(19) United States
(12) Patent Application Publication
(10) Pub. No.: US 2014/0051453 A1
(43) Pub. Date: Feb. 20, 2014

(54) BASE STATION AND COMMUNICATION CONTROL METHOD

(71) Applicants: Chiharu Yamazaki, Ota-ku Tokyo (JP); Noriyoshi Fukuta, Yokohama-shi Kanagawa (JP)

(72) Inventors: Chiharu Yamazaki, Ota-ku Tokyo (JP); Noriyoshi Fukuta, Yokohama-shi Kanagawa (JP)

(73) Assignee: KYOCERA CORPORATION, Kyoto (JP)

(21) Appl. No.: 14/113,796

(22) PCT Filed: Apr. 28, 2011
(86) PCT No.: PCT/JP2011/060423

§ 371 Date: Oct. 24, 2013

(51) Int. Cl. H04W 28/24

(52) U.S. Cl. CPC H04W 28/24
USPC 455/450

(57) ABSTRACT

A base station (eNB 100) is defined by 3GPP standards and includes a control unit (140) that, in a case where an uplink signal transmitted from a wireless terminal (UE) being served by another base station to this other base station is detected, determines the frequency band to be assigned to a wireless terminal (UE) being served by the base station (eNB 100) on the basis of the frequency band of the detected uplink signal. At least in to the other base station, the frequency band of a downlink signal is made to correspond with the frequency band of the uplink signal.

### TECHNICAL FIELD

The present invention relates to a base station and a communication control method applicable in a mobile communication system that supports a carrier aggregation technology.

### BACKGROUND ART

As the next-generation mobile communication system for achieving high speed communication with high capacity, the standardization of LTE Advanced is under progress in 3GPP (3rd Generation Partnership Project), which is a group aiming to standardize, wherein the LTE Advanced is a sophisticated version of LTE (Long Term Evolution).

In order to achieve a wide band while ensuring backward compatibility with the LTE, the LTE Advanced introduces a carrier aggregation technology in which a carrier (a frequency band) of the LTE is positioned as a component carrier, and a plurality of component carriers are collectively used to perform radio communication (for example, see Non Patent Literature 1).

### CITATION LIST

### Non Patent Literature

[Non Patent Literature 1] 3GPP technology specifications TS 36.300 V10.3.0, “5.5 Carrier Aggregation”

### SUMMARY OF INVENTION

### Technical Problem

Meanwhile, in the LTE Advanced, it is widely discussed to reduce interference by using the aforementioned carrier aggregation technology.

Thus, an object of the present invention is to provide a base station with which it is possible to reduce interference, in a mobile communication system that supports a carrier aggregation technology defined in the 3GPP standards, and a communication control method therefor.

### Solution to Problem

A base station according to a first feature is defined in the 3GPP standards, and comprises: a control unit that determines, upon a detection of an uplink signal transmitted from an another radio terminal existed under an another base station to the another base station, a frequency band to be assigned to a radio terminal existed under the base station based on a frequency band of a detected uplink signal. A frequency band of a downlink signal is at least associated with a frequency band of an uplink signal in the another base station.

In the first feature, an association between the downlink signal and the uplink signal is determined beforehand.

In the first feature, the radio base station comprises an acquisition unit that acquires information indicating the association between the downlink signal and the uplink signal from the another base station or an upper network device.

In the first feature, the control unit determines the frequency band to be assigned to the radio terminal existed under the base station, by excluding the frequency band used by the another radio terminal existed under the another base station.

In the first feature, the control unit reduces the transmission power of the signal transmitted using the frequency band used by the another radio terminal existed under the another base station, when the control unit determines the frequency band used by the another radio terminal existed under the another base station as the frequency band to be assigned to the radio terminal existed under the base station.

In the first feature, the frequency band is a component carrier defined in the 3GPP standards.

A communication control method according to a second feature is applied to a base station defined in the 3GPP standards. The communication control method comprises: a step of determining, upon a detection of an uplink signal transmitted from an another radio terminal existed under an another base station to the another base station, a frequency band to be assigned to a radio terminal existed under the base station based on a frequency band of a detected uplink signal. A frequency band of a downlink signal is at least associated with a frequency band of an uplink signal in the another base station.

### BRIEF DESCRIPTION OF DRAWINGS

FIG. 1 is a diagram illustrating a mobile communication system 1 according to a first embodiment.

FIG. 2 is a diagram illustrating a component carrier according to the first embodiment.

FIG. 3 is a diagram illustrating a base station eNB 100 according to the first embodiment.

FIG. 4 is a diagram illustrating a communication control method according to the first embodiment.

### DESCRIPTION OF EMBODIMENTS

Hereinafter, a mobile communication system according to an embodiment of the present invention will be described with reference to the accompanying drawings. Note that in the descriptions of the drawing below, identical or similar symbols are assigned to identical or similar portions.

It will be appreciated that the drawings are schematically shown and the ratio and the like of each dimension are different from the real ones. Accordingly, specific dimensions should be determined in consideration of the explanation below. Of course, among the drawings, the dimensional relationship and the ratio may be different.

### Overview of Embodiment

A base station according to embodiments is defined in the 3GPP standards, and comprises: a control unit that determines, upon a detection of an uplink signal transmitted from an another radio terminal existed under an another base station to the another base station, a frequency band to be assigned to a radio terminal existed under the base station based on a frequency band of a detected uplink signal. A frequency band of a downlink signal is at least associated with a frequency band of an uplink signal in the another base station.

The control unit determines the frequency band to be assigned to the radio terminal existed under the base station based on the frequency band of the uplink signal transmitted from the another radio terminal existed under the another base station. Therefore, the interference from the another base station and the interference exerted on the another base station can be controlled.

It must be noted that the frequency band to be assigned to the radio terminal existed under the base station could be the frequency band of the uplink signal, or the frequency band of the downlink signal.

Furthermore, the frequency band, for example, is a component carrier defined in the 3GPP standard. In other words, the component carrier is the frequency band used in one cell, for example.

### First Embodiment

### (Mobile Communication System)

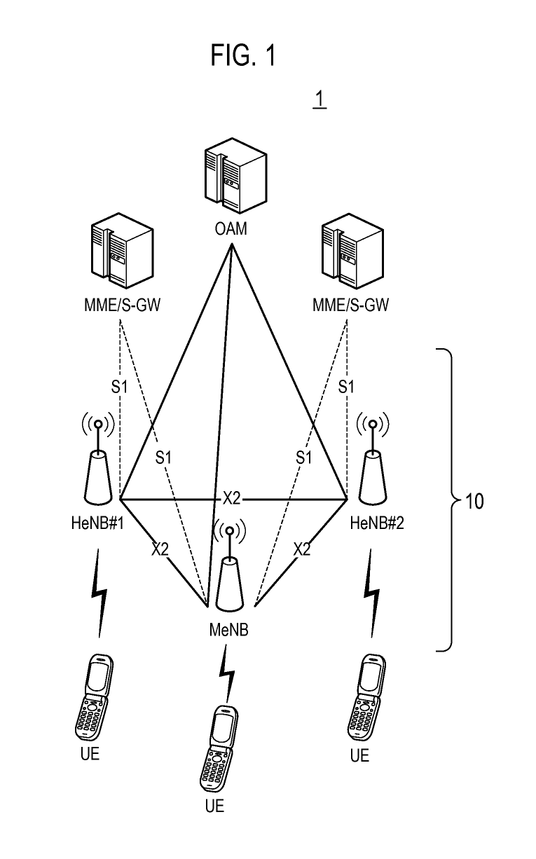

Hereinafter, a mobile communication system according to a first embodiment will be described. FIG. 1 is a diagram illustrating a mobile communication system 1 according to the first embodiment. In the first embodiment, the mobile communication system 1 is configured based on LTE Advanced (after 3GPP Release 10).

As illustrated in FIG. 1, the mobile communication system 1 includes E-UTRAN 10 (Evolved-UMTS Terrestrial Radio Access Network), which is a radio access network. The E-UTRAN 10 is configured as a heterogeneous network, and includes a plurality of types of base stations with different transmission power (that is, service area ranges).

In the first embodiment, the E-UTRAN 10 includes a macro base station MeNB that forms a large cell (macro cell) and two femto base stations HeNB (femto base station HeNB #1 and femto base station HeNB #2) that form a small cell (femto cell).

The femto base stations HeNB #1 and HeNB #2, for example, are within the service area range of the macro base station MeNB, and are arranged in a high traffic zone (that is, a hot zone). It must be noted that the number of the femto base stations HeNB arranged within the service area range of the macro base station MeNB is not limited to two, and may be one or three or more. Also note that it is possible to have a situation where no femto base stations HeNB are arranged within the service area range of the macro base station MeNB.

The service area range of the macro base station MeNB is covered by one or more cells formed by the macro base station MeNB. Similarly, the service area range of the femto base station HeNB #1 is covered by one or more cells formed by the femto base station HeNB #1, and the service area range of the femto base station HeNB #2 is covered by one or more cells formed by the femto base station HeNB #2.

Furthermore, the cell is a minimum unit of a radio communication area. However, cells are provided in each base station and may have the function of performing radio communication with the radio terminal UE.

Each of the macro base station MeNB, the femto base station HeNB #1, and the femto base station HeNB #2 supports the carrier aggregation technology. The carrier aggregation technology is a technology of performing radio communication by using a plurality of component carriers collectively. In the first embodiment, the component carrier, for example, is the frequency band used in a single cell.

The macro base station MeNB, the femto base station HeNB #1, and the femto base station HeNB #2 perform radio communication with one or a plurality of radio terminals UE. Also note that it is possible to have a situation where the macro base station MeNB, the femto base station HeNB #1, and the femto base station HeNB #2 do not perform radio communication with the radio terminal UE. In the first embodiment, the radio terminal UE that performs radio communication with the base station may sometimes be called “the radio terminal UE existed under the base station”.

The radio terminal UE supporting the carrier aggregation technology is capable of collectively using a plurality of component carriers for the purpose of radio communication.

In the mobile communication system 1 according to the first embodiment, an X2 interface is set for connecting a plurality of base stations with one another. In the first embodiment, an X2 interface is set between the macro base station MeNB and the femto base station HeNB #1, an X2 interface is set between the macro base station MeNB and the femto base station HeNB #2, and an X2 interface is set between the femto base station HeNB #1 and the femto base station HeNB #2.

However, an X2 interface need not be set between the macro base station MeNB and the femto base station HeNB.

Moreover, the mobile communication system 1 includes a mobility management device MME/a gateway device S-GW and an operation administration and maintenance device OAM. The mobility management device MME is configured to perform various types of mobility control for the radio terminal UE. The gateway device S-GW is configured to perform transfer control of user data that is transmitted and received by the radio terminal UE. The operation administration and maintenance device OAM is configured to perform maintenance and monitoring of the E-UTRAN 10. An Si interface for connecting each base station and EPC (Evolved Packet Core) is set between each base station and the EPC. The mobility management device MME, the gateway device S-GW, and the operation administration and maintenance device OAM, for example, are provided in the EPC.

(Component Carrier)

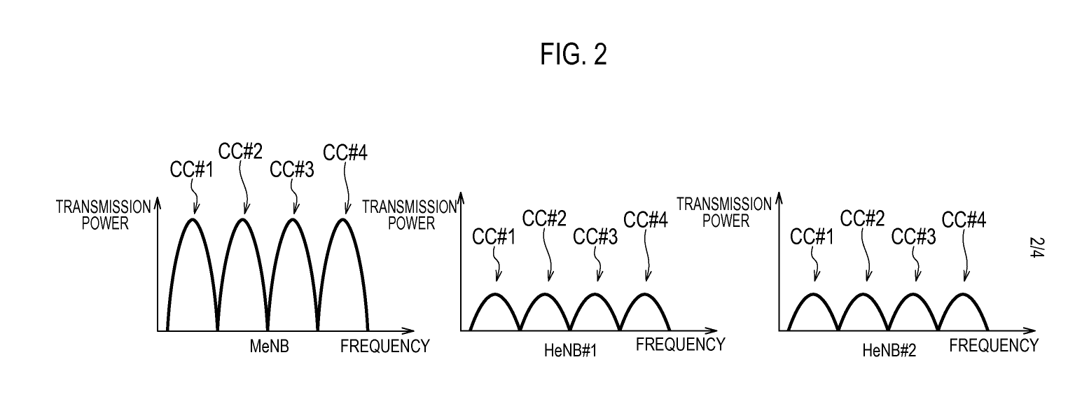

The component carrier according to the first embodiment will be described below. FIG. 2 is a diagram illustrating the component carrier according to the first embodiment.

As illustrated in FIG. 2, each base station performs radio communication by using a plurality of component carriers. A case in which each base station performs radio communication by using four component carriers is illustrated here. Of course, the number of component carriers used by each base station is not limited to four.

Furthermore, a case in which a plurality of component carriers are in continuation in the frequency axial direction is illustrated. However, the plurality of component carriers may be distributed in the frequency axial direction. For example, the plurality of component carriers may be distributed in 800-MHz bands and 1.5-GHz bands.

As illustrated in FIG. 2, each of the macro base station MeNB, the femto base station HeNB #1, and the femto base station HeNB #2 can use four component carriers (CC #1 through CC #4). Each component carrier, for example, is a frequency band used in one cell of LTE. Each component carrier is configured by a plurality of resource blocks (RB) provided along the frequency axial direction. A resource block is a unit of a radio resource that can be assigned to the radio terminal UE.

In FIG. 2, the component carriers of a downlink signal are illustrated. As illustrated in FIG. 2, the transmission power of the femto base station HeNB #1 and the femto base station HeNB #2 is lesser than the transmission power of the macro base station MeNB.

It must be noted that the component carriers of an uplink signal are also the same as the component carriers of the downlink signal illustrated in FIG. 2. In the first embodiment, the component carriers of the downlink signal and associated with the component carriers of the uplink signal.

(Base Station)

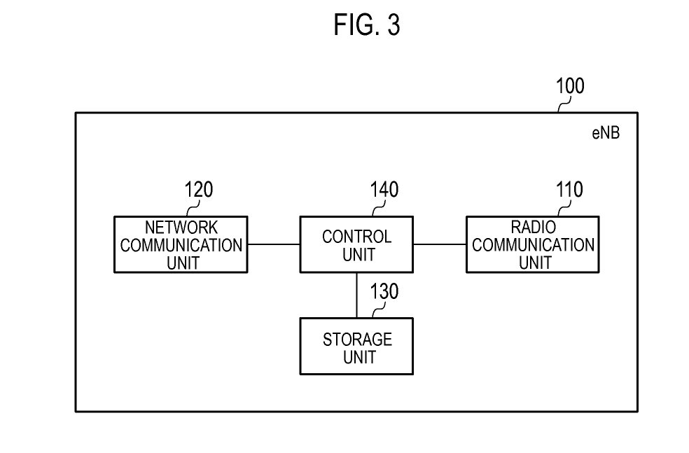

Hereinafter, a base station according to the first embodiment will be described. FIG. 3 is a block diagram illustrating the base station eNB 100 according to the first embodiment. The base station eNB 100 may be a femto base station HeNB, or a macro base station MeNB.

As illustrated in FIG. 3, the base station eNB 100 includes a radio communication unit 110, a network communication unit 120, a storage unit 130, and a control unit 140.

The radio communication unit 110 is configured to perform radio communication with the radio terminal UE. In detail, when the carrier aggregation technology is used, the radio communication unit 110 simultaneously uses a plurality of component carriers to perform radio communication.

The radio communication unit 110 is configured by, for example, a radio frequency (RF) circuit, a base band (BB) circuit, and a modulation and coding circuit. The radio communication unit 110 receives an uplink signal through an antenna (not shown in the figure). Furthermore, the radio communication unit 110 transmits a downlink signal through an antenna (not shown in the figure).

The network communication unit 120 is configured to communicate with other network devices. For example, the network communication unit 120 performs inter-base station communication with another base station through the X2 interface. Alternatively, the network communication unit 120 communicates with the EPC through the S1 interface.

The storage unit 140 is configured to store the information used for controlling the base station eNB 100. For example, the storage unit 130 stores the identification information for identifying the base station eNB 100 (base station ID), the identification information for identifying the cell that the base station eNB 100 has (for example, the cell ID), and the like.

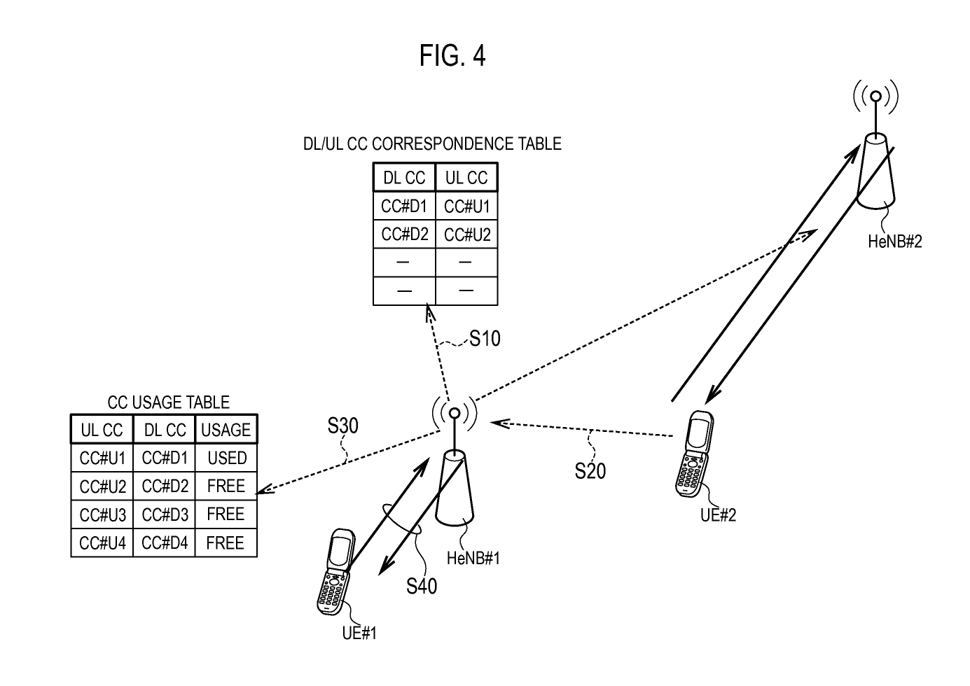

In the first embodiment, the storage unit 130 stores the information (DL/UL CC correspondence table) for associating the component carriers (the frequency band) of the downlink signal used in another base station and the component carriers (the frequency band) of the uplink signal used in another base station, and the information (CC usage table) indicating the usage status of the component carriers of the uplink signal and the component carriers of the downlink signal in the association (see FIG. 4 for an example of “DL/UL CC correspondence table” and “CC usage table”).

It must be noted that the association of the component carriers of the downlink signal and the component carriers of the uplink signal may be determined is beforehand. Alternatively, the information indicating the association between the component carriers of the downlink signal and the component carriers of the uplink signal may be acquired from another base station through the X2 interface.

The control unit 140 is configured to control the configuration provided in the base station eNB 100. For example, the control unit 140 assigns the component carriers to the radio terminal UE existed under the base station eNB 100. It must be noted that when the carrier aggregation technology is used, the control unit 140 assigns a plurality of component carriers to the radio terminal UE.

In the first embodiment, the control unit 140 detects the component carriers of the uplink signal transmitted from the radio terminal UE existed under another base station to another base station. Based on the detected component carriers of the uplink signal, the control unit 140 determines the component carriers to be assigned to the radio terminal UE existed under the base station eNB 100 (hereinafter, the component carriers to be assigned). The control unit 140 assigns the component carriers to be assigned, which were determined earlier, to the radio terminal UE, and performs radio communication with the radio terminal UE by using the assigned component carriers.

In detail, the control unit 140 uses the DL/UL CC correspondence table stored in the storage unit 130 to identify the component carriers of the downlink signal that are associated with the detected component carriers of the uplink signal.

The control unit 140 stores the information indicating the detected component carriers of the uplink signal and the component carriers of the downlink signal that are identified from the DL/UL CC correspondence table and associated with the detected component carriers of the uplink signal, in the CC usage table. Each time the control unit 140 detects the component carriers of the uplink signal transmitted from the radio terminal UE existed under another base station to another base station, the control unit 140 executes the processing of storing to the CC usage table, and updates the CC usage table.

In the CC usage table, the control unit 140 stores information indicating “used” associated with the component carriers corresponding to the component carriers used by the radio terminal UE existed under another base station, and stores information indicating “free” associated with the rest of component carriers.

The control unit 140 uses the CC usage table to exclude the detected component carriers of the uplink signal (for example, CC #U1 and CC #U2 of the “CC usage table” shown in FIG. 4), and determine the component carriers of the uplink signal that are to be assigned (for example, CC #U3 and CC #U4 of the “CC usage table” shown in FIG. 4). Alternatively, the control unit 140 excludes the component carriers of the downlink signal (for example, CC #D1 and CC #D2 of the “CC usage table” shown in FIG. 4) that are associated with the detected component carriers of the uplink signal (for example, CC #U1 and CC #U2 of the “CC usage table” shown in FIG. 4), and determines the component carriers of the downlink signal that are to be assigned (for example, CC #D3 and CC #D4 of the “CC usage table” shown in FIG. 4). That is, the control unit 140 excludes the component carriers used by the radio terminal UE existed under another base station, and determines the component carriers to be assigned.

An object of the first embodiment is to control interference. Therefore, another base station is preferably a base station having a service area range overlapping the service area range of the base station eNB 100. Alternatively, another base station is preferably a base station having a service area range adjacent to the service area range of the base station eNB 100.

Furthermore, the first embodiment is also applicable to a case in which the femto base station HeNB is installed arbitrarily by the user. In such a case, if the base station eNB 100 is the femto base station HeNB #1, then another base station is the femto base station HeNB #2. However, another base station may be a macro base station MeNB.

(Communication Control Method)

Hereinafter, a communication control method according to the first embodiment will be described. FIG. 4 is a diagram illustrating a communication control method according to the first embodiment. FIG. 4 illustrates a case in which the base station eNB 100 is the femto base station HeNB #1, and another base station is the femto base station HeNB #2.

The femto base station HeNB #2 performs radio communication with the radio terminal UE #2. In such a case, a case where the femto base station HeNB #1 assigns the component carriers used by the radio terminal UE #1 is explained.

As illustrated in FIG. 4, in step 10, the femto base station HeNB #1 stores the information (DL/UL CC correspondence table) that associates the component carriers (the frequency band) of the downlink signal used in the femto base station HeNB #2 and the component carriers (the frequency band) of the uplink signal used in the femto base station HeNB #2.

It must be noted that the association of the component carriers of the downlink signal and the component carriers of the uplink signal may be determined beforehand. Alternatively, the information indicating the association between the component carriers of the downlink signal and the component carriers of the uplink signal may be acquired from the femto base station HeNB #2 through the X2 interface.

In step 20, the femto base station HeNB #1 detects the component carriers of the uplink signal transmitted from the radio terminal UE #2 to the femto base station HeNB #2.

In step 30, the femto base station HeNB #1 identifies the component carriers of the downlink signal transmitted from the femto base station HeNB #2 to the radio terminal UE #2 based on the detected component carriers of the uplink signal. That is, the femto base station HeNB #1 uses the information stored in step 10 to identify the component carriers of the downlink signal that are associated with the detected component carriers of the uplink signal.

In step 40, the femto base station HeNB #1 determines the component carriers to be assigned to the radio terminal UE #1 (hereinafter, the component carriers to be assigned), and then assigns the component carriers to be assigned, which were determined earlier, to the radio terminal UE, and performs radio communication with the radio terminal UE #1 by using the assigned component carriers.

For example, the femto base station HeNB #1 excludes the detected component carriers of the uplink signal, and determines the component carriers of the uplink signal that are to be assigned. Alternatively, the femto base station HeNB #1 excludes the component carriers of the downlink signal that are associated with the detected component carriers of the uplink signal, and determines the component carriers of the downlink signal that are to be assigned. That is, the femto base station HeNB #1 excludes the component carriers used by the radio terminal UE #2 and determines the component carriers to be assigned.

(Operation and Effect)

In the first embodiment, the base station eNB 100 determines the component carriers to be assigned to the radio terminal UE existed under the base station eNB 100 (hereinafter, the component carriers to be assigned) based on the component carriers of the uplink signal transmitted from the radio terminal UE existed under another base station. Therefore, the interference from another base station, and the interference exerted on another base station can be controlled.

In detail, the base station eNB 100 excludes the component carriers of the uplink signal transmitted from the radio terminal UE existed under another base station, and determines the component carriers of the uplink signal that are to be assigned. Thus, the interference exerted on another base station from the radio terminal UE existed under the base station eNB 100 is reduced. In addition, the interference exerted on the base station eNB 100 from the radio terminal UE existed under another base station also reduces.

Furthermore, the base station eNB 100 excludes the component carriers of the downlink signal that are associated with the component carriers of the uplink signal transmitted from the radio terminal UE existed under another base station, and determines the component carriers of the downlink signal that are to be assigned. Thus, the interference exerted on the radio terminal UE existed under the base station eNB 100 from another base station is reduced. In addition, the interference exerted on the radio terminal UE existed under another base station from the base station eNB 100 also reduces.

In the first embodiment, the base station eNB 100 need not detect the component carriers of the downlink signal transmitted from another base station. Therefore, even in a communication system of the FDD (Frequency division duplex) scheme, the interference can be controlled without the need of having a configuration (a new configuration) for detecting the component carriers of the downlink signal. It must be noted that the function of detecting the component carriers of the uplink signal is the function that the conventional base stations possess.

### Other Embodiments

The present invention is explained through the above embodiment, but it must not be understood that this invention is limited by the statements and the drawings constituting a part of this disclosure. From this disclosure, various alternative embodiments, examples, and operational technologies will become apparent to those skilled in the art.

Particularly not mentioned in the embodiment, the base station eNB 100 may detect the component carriers of the uplink signal transmitted from the radio terminal UE existed under another base station when power is supplied. Alternatively, the base station eNB 100 may detect the component carriers of the uplink signal transmitted from the radio terminal UE existed under another base station when component carriers are assigned to the radio terminal UE.

In the embodiment, a case in which the base station eNB 100 is the femto base station HeNB #1, and another base station is the femto base station HeNB #2 is mainly illustrated. However, the embodiment is not limited thereto. For example, the base station eNB 100 may be a macro base station MeNB, and another base station may be a macro base station MeNB. Alternatively, the base station eNB 100 may be a femto base station HeNB (or a macro base station MeNB), and another base station may be a macro base station MeNB (or a femto base station HeNB). Alternatively, the femto base station HeNB may be substituted by a pico base station PeNB installed by a communication provider. Alternatively, the base station eNB 100 may be a femto base station HeNB (or a pico base station PeNB), and another base station may be a pico base station PeNB (or a femto base station HeNB).

In the embodiment, the component carriers of the downlink signal are associated with the component carriers of the uplink signal. However, the component carriers of the downlink signal may be associated with the component carriers of the uplink signal, at least in another base station.

Particularly not mentioned in the embodiment, the association between component carriers of the downlink signal and the component carriers of the uplink signal may be specified at least to another base station by the operation administration and maintenance device OAM. In such a case, the base station eNB 100 acquires the information indicating the association between the component carriers of the downlink signal and the component carriers of the uplink signal from the operation administration and maintenance device OAM, through the S1 interface. That is, the base station eNB 100 acquires the information indicating the association between the component carriers of the downlink signal and the component carriers of the uplink signal from an upper network device, through the S1 interface.

Particularly not mentioned in the embodiment, the component carriers of the downlink signal and the component carriers of the uplink signal may be associated each other when the number of the component carriers of the downlink signal and the number of the component carriers of the uplink signal are different.

In the embodiment, the base station eNB 100 (the control unit 140) excludes the component carriers used by the radio terminal UE existed under another base station, and determines the component carriers to be assigned. However, the embodiment is not limited thereto.

In detail, when the base station eNB 100 (the control unit 140) determines the detected component carriers of the uplink signal (for example, CC #U1 and CC #U2 of the “CC usage table” shown in FIG. 4) as the component carriers to be assigned to the radio terminal UE existed under the base station eNB 100, the base station eNB 100 controls the transmission power of the uplink signal so that the transmission power of the uplink signal transmitted using the detected component carriers of the uplink signal is below a predetermined value (hereinafter, this control is called “the transmission power control of the uplink signal”). For example, the base station eNB 100 (the control unit 140) controls the transmission power of the uplink signal by using closed loop transmission power control or the like, which makes use of TPC bits, etc.

Alternatively, when the base station eNB 100 (the control unit 140) determines the component carriers of the downlink signal (for example, CC #D1 and CC #D2 of the “CC usage table” shown in FIG. 4) that are associated with the detected component carriers of the uplink signal (for example, CC #U1 and CC #U2 of the “CC usage table” shown in FIG. 4) as the component carriers to be assigned to the radio terminal UE existed under the base station eNB 100, the base station eNB 100 controls the transmission power of the downlink signal so that the transmission power of the downlink signal transmitted using the component carriers of the downlink signal that are associated with the detected component carriers of the uplink signal is below a predetermined value (hereinafter, this control is called “the transmission power control of the downlink signal”).

That is, when the base station eNB 100 (the control unit 140) determines the component carriers used by the radio terminal UE existed under another base station as the component carriers to be assigned to the radio terminal UE existed under the base station eNB 100, the base station eNB 100 reduces the transmission power of the signal transmitted using the component carriers used by the radio terminal UE existed under another base station.

It must be noted that the predetermined value, for example, is the transmission power value of the signal transmitted using the component carriers that are not used by the radio terminal UE existed under another base station. Furthermore, the predetermined value may be a value that is determined beforehand.

It must be noted that when the base station eNB 100 (the control unit 140) detects an uplink signal transmitted from the radio terminal UE existed under another base station to another base station, it is preferable to execute the transmission power control of the uplink signal and the transmission power control of the downlink signal, however, the transmission power control of the uplink signal and the transmission power control of the downlink signal may not be executed based on the transmission power of the component carriers in another base station. That is, the base station eNB 100 (the control unit 140) can also assign the component carriers used by the radio terminal UE existed under another base station.

### INDUSTRIAL APPLICABILITY

According to the present invention, it is possible to provide a base station with which it is possible to select an appropriate combination of component channels in a mobile communication system that supports the carrier aggregation technology defined in the 3GPP standard, and a communication control method therefor.

1. A base station defined in the 3GPP standards, comprising:
a control unit that determines, upon a detection of an uplink signal transmitted from an another radio terminal existed under an another base station to the another base station, a frequency band to be assigned to a radio terminal existed under the base station based on a frequency band of a detected uplink signal, wherein
a frequency band of a downlink signal is at least associated with a frequency band of an uplink signal in the another base station.

2. The base station according to claim 1, wherein
an association between the downlink signal and the uplink signal is determined beforehand.

3. The base station according to claim 1, wherein
an acquisition unit that acquires information indicating the association between the downlink signal and the uplink signal from the another base station or an upper network device.

4. The base station according to claim 1, wherein
the control unit determines the frequency band to be assigned to the radio terminal existed under the base station, by excluding the frequency band used by the another radio terminal existed under the another base station.

5. The base station according to claim 1, wherein
the control unit reduces the transmission power of the signal transmitted using the frequency band used by the another radio terminal existed under the another base station, when the control unit determines the frequency band used by the another radio terminal existed under the another base station as the frequency band to be assigned to the radio terminal existed under the base station.

6. The base station according to claim 1, wherein
the frequency band is a component carrier defined in the 3GPP standards.

7. A communication control method in a base station defined in the 3GPP standards, comprising:
a step of determining, upon a detection of an uplink signal transmitted from an another radio terminal existed under an another base station to the another base station, a frequency band to be assigned to a radio terminal existed under the base station based on a frequency band of a detected uplink signal, wherein
a frequency band of a downlink signal is at least associated with a frequency band of an uplink signal in the another base station.
